(19) United States
(12) Patent Application Publication
(10) Pub. No.: US 2004/0042445 A1
(43) Pub. Date: Mar. 4, 2004

(54) Quality evaluation equipment of network speaking

(76) Inventor: Kazuhiro Kashiwagi, Tokyo (JP)

Correspondence Address: LEWIS F. GOULD, JR., DUANE MORRIS LLP, ONE LIBERTY PLACE, PHILADELPHIA, PA, 19103, US

(21) Appl. No.: 10/377,201

(22) Filed: Feb. 28, 2003

(30) Foreign Application Priority Data
Aug. 28, 2002 (JP) 2002-248150

(51) Int. Cl. H04L 12/66

(52) U.S. Cl. 370/352

(57) ABSTRACT

A quality evaluation equipment 1 of a network speaking system capable of measuring and computing speaking quality of voice speaking by exchanging speaking data comprised of voice packets 6 through a communication network 2. A speaking control unit 50 is provided with a computing contents detecting portion for detecting kind and number of measurement and computing of quality of speaking in the respective speaking terminals 3, 7, a quantity of load computing portion for computing quantity of load on the basis of the kind and the number of the measurement and the computing, and a computing contents record portion for recording the kind and the number of measurement and computing, and quantity of load, thereby computing the computing contents and the quantity of load.

### BACKGROUND OF THE INVENTION

This invention relates to a quality evaluation equipment for conducting quality evaluation of network speaking with a voice packet, and more specifically to a quality evaluation equipment capable of recording contents and quantity of load of measurement and computing every speaking terminal.

A network communication for speaking with voice, making use of a communication network, such as the Internet or a dedicated communication network, has lately been put to practical use. In order to speak with voice in such a network communication, communication data divided into packets are exchanged between terminals for speaking, thereby voice quality (tone) may deteriorate by delay, jitter (fluctuation of reaching time) or disappearing in the middle of transfer concerning the packet.

Under this situation, a quality evaluation equipment for diagnosing and evaluating the place on the network of the cause of deterioration of voice quality, and for judging in which state the quality of voice speaking in many speaking terminals is, specifically for a person of communication business or a network manager, has been proposed.

In the above-mentioned quality evaluation equipment, many kinds, such as objective evaluation value for objectively evaluating the quality of the voice speaking, are computed in addition to the measurement of delay, jitter (fluctuation of reaching time) or disappearing in the middle of transfer concerning the packet. A more correct result can be obtained by repeating this measurement or computing a plurality of times. But, the quantity of load of the measurement or computing is different from each other by the quantity of computing on the quality evaluation equipment owing to the above-mentioned kinds. Besides, the number of the measurement and computing is different every user according to time of speaking, number of speaking, number of terminals connected or the like. Therefore, no clear method as to how to quantitatively compute the contents and the quantity of load of the measurement and computing in the case where the above-mentioned person of communication business or a network manager charges for measurement fees based on quantity of load of the quality evaluation equipment to a user of the equipment or in the case where a user is informed of state of use of the quality evaluation equipment has been established.

Therefore, the development of the quality evaluation equipment of the network speaking for solving the above-mentioned problems has been desired.

### SUMMARY OF THE INVENTION

The present invention is a quality evaluation equipment of network speaking to be used for a network speaking system for speaking with voice between a plurality of speaking terminals by exchanging speaking data comprised of a plurality of voice packets through a communication network,

said quality evaluation equipment of network speaking comprising:

speaking quality monitoring units for measuring and computing speaking quality evaluation data through which speaking quality of network speaking can be evaluated, provided between said communication network and a plurality of said speaking terminals, and a speaking control unit for collecting said speaking quality evaluation data;

said speaking control unit further comprising:

means of detecting computing contents for detecting a kind and a number of said measurement and computing in each of a plurality of said speaking terminals;

means of computing quantity of load for computing quantity of load on the basis of said kind and said number of said measurement and computing;

means of recording computing contents for recording said kind and said number of said measurement and computing detected by said means of detecting computing contents, and said quantity of load computed by said means of computing quantity of load.

According to this invention, the speaking control unit is provided with means of detecting computing contents for detecting a kind and a number of the measurement and computing in each of a plurality of the speaking terminals, means of computing quantity of load for computing quantity of load on the basis of the kind and the number of the measurement and computing, and means of recording computing contents for recording the kind and the number of the measurement and computing detected by the means of detecting computing contents, and the quantity of load computed by the means of computing quantity of load. When a person of communication business or a network manager charges for measurement fees as quantity of load (quantity of use) to a user, or a user is informed of state of use, therefore the quantity of load (quantity of use) can be computed and a detailed statement can be issued.

Besides, the present invention is the quality evaluation equipment of network speaking, wherein said means of detecting computing contents detects measurement and computing of jitter, disappearing, delay, reciprocating delay time and objective tone evaluation value concerning said voice packet as a kind of said measurement and said computing every said kind, and said means of computing quantity of load computes said quantity of load on the basis of load on said every kind and number.

According to this invention, the means of detecting computing contents detects measurement and computing of jitter, disappearing, delay, reciprocating delay time and objective tone evaluation value concerning the voice packet as a kind of the measurement and the computing every kind, and the means of computing quantity of load computes the quantity of load on the basis of the load every kind and number, thereby detailedly computing the computing contents and the quantity of load (quantity of use).

The present invention is the quality evaluation equipment of network speaking, further comprising:

means of distributing software provided on said communication network, said means of distributing software capable of distributing a program for measurement for measuring and computing said speaking quality evaluation data to said speaking quality monitoring unit, wherein said means of recording computing contents records number of distribution of said program for measurement by said means of distributing software and quantity of load by said distribution.

According to this invention, the communication network is provided with means of distributing software capable of distributing a program for measurement to the speaking quality monitoring unit, and the means of recording computing contents records number of distribution of the program for measurement by the means of distributing software and quantity of load by the distribution, thereby computing quantity of load (quantity of use) according to the distribution of the program for measurement and its number.

Besides, the present invention is the quality evaluation equipment of network speaking, further comprising:

means of distributing encoded data provided on said communication network, said means of distributing encoded data capable of distributing encoded data obtained by encoding voice data to be used for measurement to said speaking quality monitoring unit, wherein said speaking quality monitoring unit measures said speaking quality evaluation data on the basis of said encoded data distributed, and said means of recording computing contents records number of distribution of said encoded data by said means of distributing encoded data and quantity of load by said distribution.

According to this invention, the communication network is provided with means of distributing encoded data capable of distributing encoded data obtained by encoding voice data to be used for measurement to the speaking quality monitoring unit, the speaking quality monitoring unit measures the speaking quality evaluation data on the basis of the encoded data distributed, and the means of recording computing contents records number of distribution of the encoded data by the means of distributing encoded data and quantity of load by the distribution, thereby the quantity of load (quantity of use) can be computed according to the distribution of the encoded data and its number while the voice data to be used for measurement can be obtained from the encoded data as it is.

The present invention is the quality evaluation equipment of network speaking, wherein said means of distributing encoded data has said encoded data every kind of codec.

According to this invention, the means of distributing encoded data has the encoded data every kind of codec. Therefore, the encoded data can be distributed in spite of any kind of codec. And, the speaking quality monitoring unit can obtain the voice data to be used for measurement from the encoded data as it is if the distribution is received even if the voice data is encoded by any kind of codec.

Besides, the present invention is the quality evaluation equipment of network speaking, wherein said speaking quality monitoring unit is a computer.

According to this invention, the speaking quality monitoring unit is a computer so that the computer can receive distribution of the program for measurement or encoded data and can also function as the speaking quality monitoring unit, functioning as the speaking terminal.

### BRIEF DESCRIPTION OF THE DRAWINGS

FIG. 1 is a schematic diagram for showing an example of a communication network to which the present invention is applied;

FIG. 2 is a block diagram for showing an example of a speaking quality monitoring unit;

FIG. 3 is a block diagram for showing an example of a case where a computer is used for a speaking quality monitoring unit;

FIG. 4 is a block diagram for showing an example of a network speaking control unit; and

FIG. 5 is an explanatory drawing for showing an instance of a record of contents of computing, (a) is a table for showing a state of being recorded by a computing contents record portion and (b) is a table for showing weighting of quantity of load by a quantity of load computing portion.

### DESCRIPTION OF THE PREFERRED EMBODIMENT

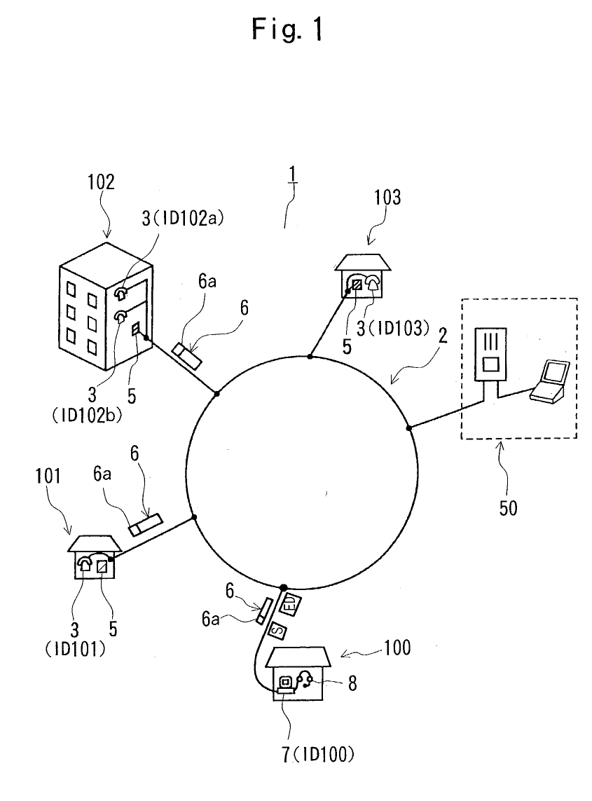

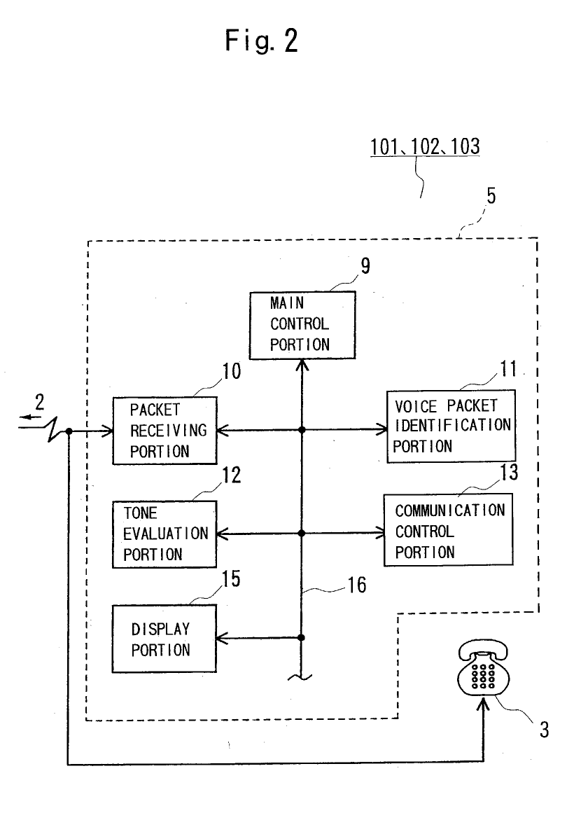

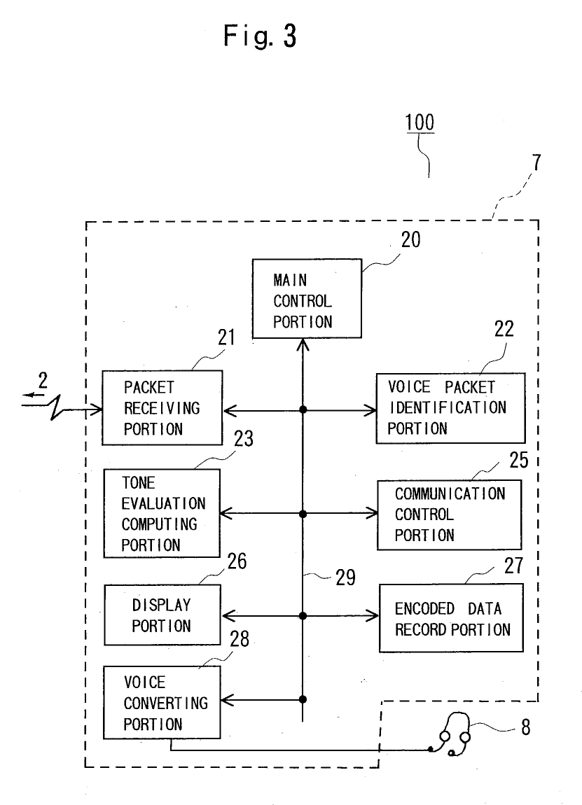

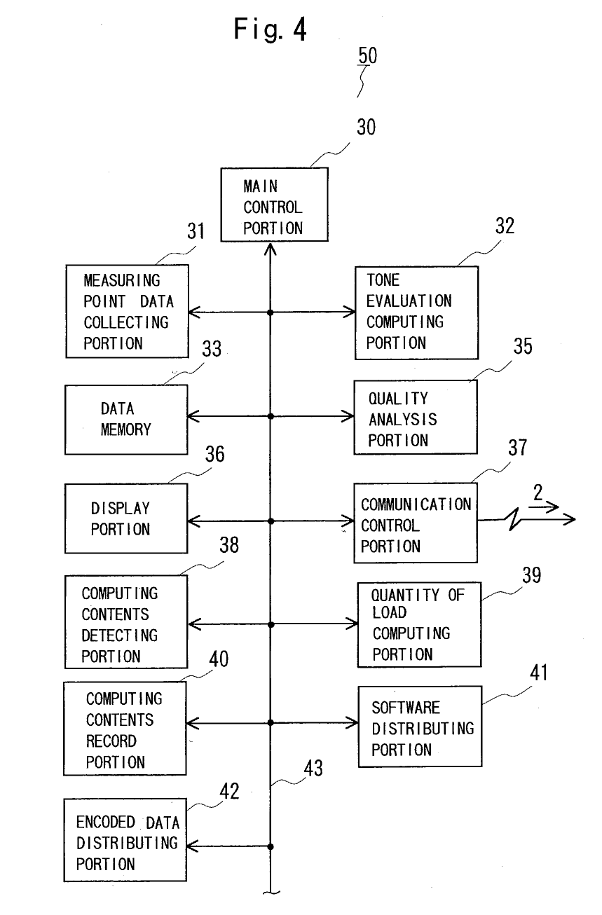

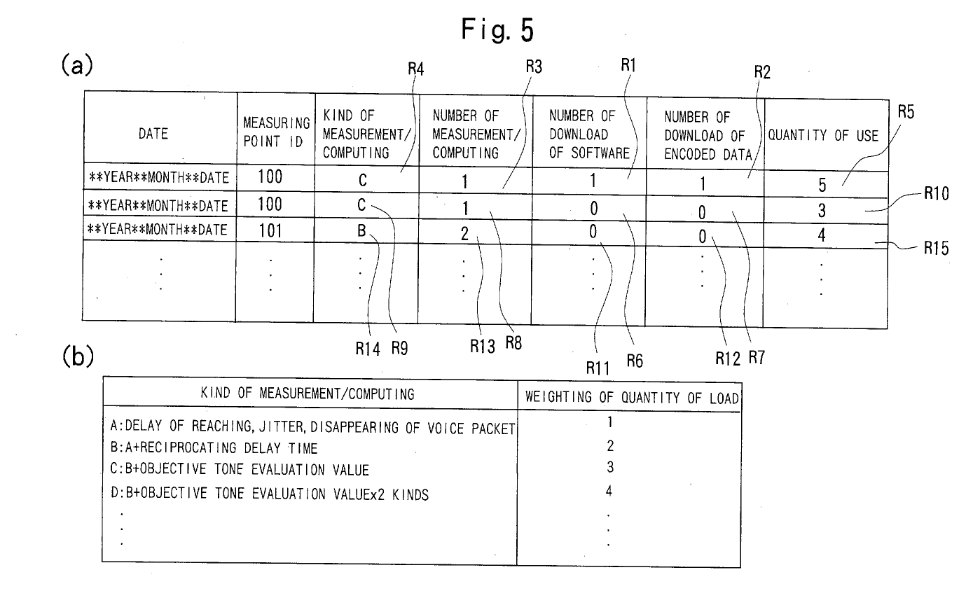

An embodiment of the present invention will now be explained hereinafter, referring to drawings. FIG. 1 is a schematic diagram for showing an example of a communication network to which the present invention is applied, FIG. 2 is a block diagram for showing an example of a speaking quality monitoring unit, FIG. 3 is a block diagram for showing an example of a case where a computer is used for a speaking quality monitoring unit, FIG. 4 is a block diagram for showing an example of a network speaking control unit, and FIG. 5 is an explanatory drawing for showing an instance of a record of contents of computing, (a) is a table for showing a state of being recorded by a computing contents record portion and (b) is a table for showing weighting of quantity of load by a quantity of load computing portion.

As shown in FIG. 1, a communication network equipment (quality evaluation equipment of network speaking) 1 has a communication network 2 through which packet data communication is executed by a communication method, such as the internet protocol. This communication network 2 is a network managed by a specific network manager, which can be used for only a specific member permitted by the network manager, or a public network available for anyone by connecting therewith.

Many speaking terminals 3, each having an IP address, are connected with the communication network 2. A speaking quality monitoring unit 5 comprising a quality evaluation equipment of network speaking according to the present invention is arranged between each speaking terminal 3 and the communication network 2 such that the unit 5 and the speaking terminal 3 are arranged in parallel as shown in dwelling houses 101, 103, for instance. The connection form between the speaking quality monitoring unit 5 and each speaking terminal 3 is that one or more speaking terminals 3 are connected with one speaking quality monitoring unit 5, and the speaking quality monitoring unit 5 differentiates a voice speaking from the communication network 2 to each speaking terminal 3 by a well-known destination information 6a including an IP address, attached to a packet (only “a voice packet 6” hereinafter) including voice data, being transmitted from the communication network 2 to each speaking terminal 3.

Then, the speaking quality monitoring unit 5 can easily judge to which speaking terminal 3 each of many voice packets 6 transmitted from the speaking terminal 3 and the communication network 2 is addressed by referring to the IP address attached to the destination information 6a of each voice packet 6 only by providing a single speaking quality monitoring unit 5 even if a building, such as a multiple dwelling house 102, has many speaking terminals 3.

Besides, the communication network 2 may be provided with a computer 7 functioning as the speaking quality monitoring unit on the basis of a software mentioned in detail hereinafter, as shown in a dwelling house 100, for instance. In this case, the computer 7 itself functions as a speaking terminal also if the computer 7 has a headphone 8 with microphone, for instance. Various kinds of computers, such as a personal computer, a so-called PDA (personal digital assistant), a workstation are available as the computer 7.

On this occasion, an ID number is given to each of the speaking terminals 3 and the computer 7 as the speaking terminal which are provided on the dwelling houses 100, 101, 103 and the multiple dwelling house 102 in order to individually identify. As an instance, ID of the computer 7 of the dwelling house 100 is ID100, the IDs of the speaking terminals 3 of the dwelling houses 101, 103 are ID101 and ID 103, respectively, and the IDs of the speaking terminals 3, 3 of the multiple dwelling house 102 are ID102a and ID102b, respectively.

As shown in FIG. 2, the speaking quality monitoring unit 5 has a main control portion 9, and a packet receiving portion 10 connected with the network 2, a voice packet identification portion 11, a tone evaluation computing portion 12, a communication control portion 13, and a display portion 15 are connected with the main control portion 9 through a bus line 16. The speaking terminal 3 is connected with the packet receiving portion 10 in parallel. But, the connection form between the speaking terminal 3 and the speaking quality monitoring unit 5 is not always parallel connection with respect to the network 2 as shown in FIGS. 1 and 2, but both may be connected in series.

Besides, the computer 7 functions as a main control portion 20, a packet receiving portion 21 connected with the network 2, a voice packet identification portion 22, a tone evaluation computing portion 23, a communication control portion 25, a display portion (such as a monitor) 26, an encoded data record portion 27 and a voice converting portion 28 through a bus line 29 by operating a program for measurement (referred to as “a measuring software S” hereinafter) with a CPU (not shown) for instance, as shown in FIG. 3. The headphone with microphone 8 is connected with the voice converting portion 28.

On the other hand, a network speaking control unit 50, comprising a quality evaluation equipment of network speaking according to the present invention, is connected with the network 2 together with the speaking quality monitoring unit 5 and the computer 7, as shown in FIG. 1. As shown in FIG. 4, the network speaking control unit 50 has a main control portion 30. With the main control portion 30, a measuring point data collecting portion 31, a tone evaluation computing portion 32, a data memory 33, a quality analysis portion 35, a display portion 36 and a communication control portion 37, connected with the communication network 2, a computing contents detecting portion 38, a quantity of load computing portion 39, a computing contents record portion 40, a software distributing portion 41, and an encoded data distributing portion 42 are connected through a bus line 43.

The communication network 2 has the above-mentioned structure. In case of the speaking between the respective speaking terminals 3 and/or the computers 7 as the speaking terminals (referred to as “the speaking terminals 3, 7 hereinafter), which are connected with the communication network 2, voice data is transmitted onto the communication network 2 by the speaking terminal 3 or the voice converting portion 28 of the computer 7 on taking side, divided into many voice packets 6. When the voice data is transmitted, the data are generally encoded (compressed) with some codec (program for compression/extract) in order to decrease quantity of data to be transmitted. But, the voice data may be transmitted without encoding. And, the measuring software S can be free to be delivered from the software distributing portion 41 of the network speaking control unit 50, and the computer 7 downloads the measuring software S through the network 2 and installs this so that the computer 7 can function as the speaking terminal and the speaking quality monitoring unit.

As already explained, the IP address of the speaking terminal 3, 7 of the receiving side, to which voice data is transmitted, is stored in each voice packet 6 as the destination information 6a. And, the speaking quality monitoring unit 5 connected with the network 2 gets the voice packet identification portion 11, 22 to watch the voice packet 6 flowing on the network 2 through the packet receiving portion 10, 21 of FIG. 2 and FIG. 3, and identifies only voice packet 6 attaching the IP address thereon of the speaking terminal 3 connected with own speaking quality monitoring unit 5 or the IP address of the computer 7 itself so as to instruct the packet receiving portion 10, 21 to capture. Similarly, each speaking terminal 3 identifies only voice packet addressed to his own out of the voice packets 6 flowing on the communication network 2 so as to capture.

That is, telephone speaking is realized in such a manner that only voice packet 6 corresponding with own IP address is captured at the speaking terminal 3 on the receiving side, and these voice packets 6 are decoded (restructured or extracted) in the inside so as to output as a voice signal, or only the voice packet 6 corresponding with own IP address is captured in the computer 7 by the packet receiving portion 21 so as to output the voice packet 6 decoded by the voice converting portion 28 to the headphone with microphone 8, for instance, as voice signal. On this occasion, encoding or decoding of the voice packet 6 conducted by the speaking terminal 3 may be also executed by the speaking quality monitoring unit 5. Otherwise, a dedicated unit may be attached to the speaking terminal 3 so as to use a regular telephone set as the speaking terminal 3.

On this occasion, many voice packets 6 transferred from the speaking terminal 3 or 7 of the taking side are received by the speaking terminal 3 or 7 of the receiving side via various routes on the network 2, thereby delay of reaching of the voice packet 6, jitter, disappearance of the voice packet 6 or the like occur. Then, the speaking quality monitoring unit 5 connected with the speaking terminal 3, 7 or the computer 7 as the speaking quality monitoring unit (referred to as “the speaking quality monitoring unit 5, 7” hereinafter) on the receiving side obtains raw data every speaking quality parameter, such as delay of the reaching of the voice packet 6, jitter, disappearing of the voice packet 6, delay, reciprocating delay time, several kinds of objective tone evaluation values concerning the voice packet 6 of the speaking terminal 3 on the receiving side received at the packet receiving portion 10, 21 by a well-known method, and computes and measures the speaking quality evaluation value at that point of time by weighting or referring to a table from the raw data obtained in the tone evaluation computing portion 12, 23, and registers it in the memory (not shown) together with its communicating register. On this occasion, the reciprocating delay time is measured between the speaking terminal 3, 7 of the taking side and the speaking terminal 3, 7 of the receiving side, and the objective tone evaluation value is computed and judged by decoding the voice packet 6.

Besides, it is necessary to voice by restructuring (decoding) voice data from the voice packet for any of the several kinds of the objective tone values in order to evaluate objective tone by the tone evaluation computing portion 12, 23. Since the voice packet has fluctuation (jitter) of reaching time, the processing for absorbing fluctuation in the actual speaking terminal 3, 7 is executed so as to voice. Accordingly, the tone evaluation computing portion 12, 23 is provided with the means of absorbing jitter, and when the quality evaluation value is obtained, the fluctuation of the reaching time is absorbed by the means of absorbing jitter and the voice data is decoded so as to evaluate the tone on the basis of the voice data decoded. By doing so, the tone evaluation computing portion 12, 23 can compute objective tone evaluation value, absorbing jitter, that is, on the basis of the voice data corresponding to the voice actually transferred to the receiving person with the speaking terminal 3, 7, and proper evaluation is possible.

There are several methods in order to absorb this fluctuation of the reaching time. For instance, the voice packet is held for a constant time and the processing is executed so as to restructure to such a degree that playing back is possible with original time later, thereby the influence of fluctuation can be softened and absorbed. Besides, it is preferable that the degree of absorbing fluctuation of the reaching time by the means of absorbing jitter at the time of computing objective tone evaluation value can be properly adjusted, fitting to the characteristic of the speaking terminal 3, 7.

After the speaking quality evaluation value at the time of speaking concerning the specific speaking terminal 3 connected with the speaking quality monitoring unit 5 or the computer 7 as the speaking quality monitoring unit and the speaking terminal is computed by the tone evaluation computing portion 12, 23 in this way, the main control portion 9, 20 displays the speaking quality evaluation value computed on the display portion 15, 26. Various kinds of forms, for instance, evaluation with five stages and a diagram, are thinkable as the display form of this speaking quality evaluation value. On the other hand, the measuring point data collecting portion 31 of the network speaking control unit 50 communicates with each speaking quality monitoring unit 5, 7 connected with the communication network 2 through the communication network 2 every predetermined time and collects the data of the speaking quality evaluation value concerning the speaking monitored concerning each speaking terminal 3, 7 by its speaking quality monitoring unit 5, 7 as the speaking quality evaluation data so as to store in the data memory 33. And, if necessary or every predetermined time, the reciprocating delay time is measured between the specific or all speaking quality monitoring units 5 by the tone evaluation computing portion 32. And, the objective tone evaluation value is computed by the tone evaluation computing portion 32 in such a manner that the voice test data owned in advance by the speaking quality monitoring unit 5, 7 and the network speaking control unit 50 are mutually exchanged. The results are stored in the data memory 33 as the speaking quality evaluation data.

As mentioned above, it is necessary to encode voice data on the basis of some codec in order to transmit or receive the voice data. Then, a large amount of computing is necessary for encoding the voice data, and the load on (the CPU of) the speaking quality monitoring unit 5, 7 is bigger thereby. On the other hand, the voice data at the time of speaking is comprised of various kinds of voice, then it is difficult to separately compare various kinds of voice data so as to evaluate. Therefore, specific voice data (the style by the same person by the same language, for instance) is used for measurement and the specific voice data are compared with each other with time series so as to obtain a correct voice evaluation value.

Then, the network speaking control unit 50 is provided with the encoded data distributing portion 42, as shown in FIG. 4, and the computer 7, for instance, is provided with the encoded data record portion 27 as shown in FIG. 3 in the present invention so as to record the encoded data ED obtained by encoding the voice data to be used for measurement, which is downloaded (delivered) from the network speaking control unit 50 through the network 2. When the voice data is exchanged between the speaking quality monitoring unit 5, 7 and the network speaking control unit 50 in order to obtain voice evaluation value, the encoded data ED downloaded to the encoded data record portion 27 is transmitted as it is without encoding the voice data by the monitoring unit 5, 7 so as to obtain the data for computing the quality evaluation value. By doing so, the quantity of computing by the computer 7 is decreased so as to decrease the load. Even if the computing performance of the computer 7 is low, tone evaluation value can be measured and computed without a problem.

Needless to say, the speaking quality monitoring unit 5 may be also provided with the encoded data record portion for downloading and recording encoded data ED so that the encoded data ED can be transmitted as it is without encoding the voce data to be used for measurement in order to obtain the data for obtaining the quality evaluation value. And, the respective encoded data ED are prepared according to various kinds of codec in the encoded data distributing portion 42 so as to be free to be distributed, and the encoded data record portion can download the encoded data ED corresponding to various kinds of codec according to its necessity. That is, the data for obtaining the speaking quality evaluation can be obtained without encoding the voice data to be used for measurement concerning the voice speaking encoded by any codec with the speaking quality monitoring unit to which various kinds of encoded data ED are downloaded in advance.

After the network speaking control unit 50 finishes collecting the speaking quality evaluation value concerning each speaking terminal 3, 7 from all speaking quality monitoring units 5, 7 connected with the communication network 2 at some point of time, the speaking quality of the whole communication network 2 at the point of time is evaluated on the basis of a predetermined evaluation standard by the quality analysis portion 35 from these evaluation values (The speaking quality of a part of the area comprised of a plurality of speaking terminals 3, 7 may be evaluated, not always of the whole communication network 2) so as to obtain the network speaking quality evaluation value, and the network speaking quality evaluation value obtained is displayed on the display portion 36. If this network speaking quality evaluation value is lower than a predetermined value and the quality of the voice speaking in the communication network 2 is lower than a predetermined standard, it is displayed on the display portion 36 and a network manager controlling the communication network 2 through the communication control portion 37 is notified of predetermined data, such as with an alarm and a report. These data may be a predetermined alarm signal. Then, the network manager can immediately perceive in which state the speaking quality of the present communication network 2 is.

On this occasion, the speaking quality evaluation data collected by the network speaking control unit 50 is not always the speaking quality evaluation value computed by each speaking quality monitoring unit 5, 7, but may be raw data concerning the speaking quality parameter, such as delay of reaching of the voice packet 6, jitter, disappearing of the voice packet 6, reciprocating delay time, and several kinds of objective tone evaluation value concerning the speaking quality, which are the basis for computing the speaking quality evaluation value. Such raw data concerning the speaking quality parameter may be collected as the speaking quality evaluation data so as to compute the speaking quality of the network 2 on the network speaking control unit 50 side on the basis of the raw data concerning the speaking quality parameter. By doing so, it is not necessary to provide a large scaled unit on the speaking quality monitoring unit 5 and the bigger load on the computer 7 is not necessary so as to make the speaking quality monitoring unit 5 smaller and so as to decrease the load concerning the computing ability of the computer 7. In this case, the speaking quality evaluation value on each speaking quality monitoring unit 5, 7 side may be computed so as to notify the speaking quality monitoring unit 5, 7, if necessary. In this case, the notified speaking quality evaluation value is displayed on the display portion 15, 26 on the speaking quality monitoring unit 5, 7 side.

On this occasion, the minimum value, the maximum value and the mean value of delay of reaching of the voice packet 6, jitter, reciprocating delay time, and objective tone evaluation value can be used as the above-mentioned speaking quality parameter, and number disappeared, length, rate of disappearing or time distribution of the disappearing of the packet 6 can be used as the parameter.

Besides, the instruction of evaluating and computing of the speaking quality may be input through a proper input means of the network speaking control unit 50, and the speaking quality data may be obtained from each speaking quality monitoring unit 5, 7 at an optional time so as to compute the speaking quality concerning the communication network 2.

When each speaking quality monitoring unit 5, 7 and the network speaking control unit 50 measures and computes delay of reaching of the voice packet 6, jitter, disappearing of the voice packet 6, reciprocating delay time, or objective tone evaluation value or downloads the measuring software S or the encoded data ED, the load for computing occurs on these speaking quality monitoring unit 5, 7 and the network speaking control unit 50. Then, the kind or the number of the measurement or computing above-mentioned, and the number of download are detected by the computing contents detecting portion 38 as shown in FIG. 4 so as to sort every kind of the measurement and the computing which is determined in advance (A, B, C, D . . . ). And, the kind of measurement and the computing sorted as shown in FIG. 5(b) and its number are stored per day, for instance, in the data memory 33, corresponding to the measuring point ID of the speaking terminal 3, 7 (or the speaking quality monitoring unit 5, 7) through which measurement is conducted by the computing contents record portion 40 as shown in the table of FIG. 5(a).

On the other hand, the respective quantity of the load of computing, each being weighted every quantity of load on the quality evaluation equipment 1, different according to the kind of measurement or computing are recorded in a proper memory, for instance, of the quantity of load computing portion 39, as shown in the table of FIG. 5(b). Explaining in detail, measurement/computing kind A refers to the case where “delay of reaching of the voice packet, jitter, disappearing” are measured and computed wherein the weighting of the quantity of load is “one (1)”, measurement/computing kind B refers to the case where “reciprocating delay time” is measured and computed in addition to the measurement/computing kind A wherein the weighting of the quantity of load is “two (2)”, measurement/computing kind C refers to the case where “objective tone evaluation value” is measured and computed in addition to the measurement/computing kind B wherein the weighting of the quantity of load is “three (3)”, and measurement/computing kind D refers to the case where two kinds of “objective tone evaluation value” are measured and computed in addition to the measurement/computing kind B wherein the weighting of the quantity of load is “four (4)”. That is, the weighting of the quantity of load according to the quantity of load on the quality evaluation equipment 1 is determined in advance and recorded. And, the quantity of load computing portion 39 computes quantity of use (that is, quantity of load) as described hereinafter on the basis of each quantity of load of computing every kind of measurement and computing as shown in FIG. 5(b) and the number of download of the measuring software S and the encoded data ED so as to store in the data memory 33 as shown in the table of FIG. 5(a).

An instance will now be concretely explained. When the computer 7, ID 100, downloads the measuring software S by the software distributing portion 41 of the network speaking control unit 50, the computing contents detecting portion 38 detects the software download so as to record “one (1)” as the number of the software download as shown in the column R1 of line one of the table of FIG. 5(a) in the data memory 33 by the computing contents record portion 40. When the computer 7 downloads the encoded data ED by the encoded data distributing portion 42 of the network speaking control unit 50, the computing contents detecting portion 38 detects the download of the encoded data ED so as to record “one (1)” as the number of the download of the encoded data as shown in the column R2 of line one (1) of the table of FIG. 5(a) in the data memory 33 by the computing contents record portion 40.

When the computer 7, for instance, subsequently once measures and computes delay of reaching of the voice packet, jitter, disappearing, reciprocating delay time, and objective tone evaluation value (one kind) at the time of speaking with another speaking terminal 3, 7, the speaking terminal 7 and the network control unit 50 communicate with each other through the network 2, thereby being detected by the computing contents detecting portion 38 of the network speaking control unit 50 that the measurement/computing kind is “C” and the number of the measurement/computing is one time, as shown in FIG. 5(b). And, the measurement/computing kind “C” and the number of measurement/computing “one (1)” are recorded in the data memory 33, as shown in the columns R3, R4 of line 1 of the table of FIG. 5(a) by the computing contents record portion 40 of the network speaking control unit 50. Since the weighting of the measurement/computing kind “C” is “three (3)” as shown in FIG. 5(b) and the number of download of software is “one (1)” and the number of download of the encoded data is “one (1)”, the quantity of load computing portion 39 computes that the quantity of use is “five (5)” (that is, “three (3)“×1+” one (1)“+” one (1)“=” five (5)” so as to record the quantity of use “five (5)” in the data memory 33 by the computing contents record portion 40, as shown in the column R5 of line one (1) of the table of FIG. 5(a).

When the computer 7 once measures and computes delay of reaching of the voice packet, jitter, disappearing, reciprocating delay time, and objective tone evaluation value (one kind) at the time of speaking with another speaking terminal 3, 7, subsequently, on the other date, for instance, as shown in line two (2) of the table of FIG. 5(a), the speaking terminal 7 and the network control unit 50 communicate with each other through the network 2, thereby being similarly detected by the computing contents detecting portion 38 of the network speaking control unit 50 that the measurement/computing kind is “C” and the number of the measurement/computing is one time so as to record in the data memory 33, as shown in the columns R8, R9 of line 2 (two) of the table of FIG. 5(a) by the computing contents record portion 40 of the network speaking control unit 50. Since no software or no encoded data is downloaded as shown in the columns R6, R7 of line two (2) of the table of FIG. 5(a), the quantity of load computing portion 39 computes that the quantity of use is “three (3)” (that is, “three (3)“×1=” three (3)” so as to record the quantity of use “three (3)” in the data memory 33 by the computing contents record portion 40, as shown in the column R10 of line two (2) of the table of FIG. 5(a).

When the speaking terminal 3 which is ID101 of the dwelling house 101 twice measures and computes delay of reaching of the voice packet, jitter, disappearing, reciprocating delay time at the time of speaking with another speaking terminal 3, 7, as shown in line three (3) of the table of FIG. 5(a), the speaking terminal 7 and the network control unit 50 communicate with each other through the network 2, thereby being detected by the computing contents detecting portion 38 of the network speaking control unit 50 that the measurement/computing kind is “B” and the number of the measurement/computing is two times so as to record in the data memory 33, as shown in the columns R13, R14 of line 3 (three) of the table of FIG. 5(a) by the computing contents record portion 40 of the network speaking control unit 50. Since no software or no encoded data is downloaded as shown in the columns R11, R12 of line three (3) of the table of FIG. 5(a), the quantity of load computing portion 39 computes that the quantity of use is “four (4)” (that is, “two (2)“×2=” four (4)” so as to record the quantity of use “four (4)” in the data memory 33 by the computing contents record portion 40 of the network speaking control unit 50, as shown in the column R15 of line three (3) of the table of FIG. 5(a).

When the measurement and computing are similarly conducted thereafter, the kind, the number, the quantity of use are always recorded in the data memory 33. When a person of communication business or a network manager charges for measurement fees based on the quantity of load (that is, quantity of computing) to a user by totalizing once a month, for instance, or a user is informed of state of use, therefore, it is possible to compute the quantity of use and issue a detailed statement. Besides, the measurement and computing of jitter, disappearing, delay, reciprocating delay time and objective tone evaluation value concerning the voice packet 6 are respectively detected as the kind of measurement and computing, and the quantity of load is computed on the basis of the load for the kind thereof and the number of times, thereby the computing contents or the quantity of load (quantity of use) can be more detailedly computed. Furthermore, the download of software or encoded data is also recorded, thereby computing the quantity of load (quantity of use) occurring at the time of download of software or encoded data.

The present embodiment explained above refers to the network speaking control unit 50 having the software distributing portion 41 for distributing the measuring software S and the encoded data distributing portion 42 for distributing the encoded data ED. But, the present invention does not limit to such a structure. The software distributing portion 41 and the encoded data distributing portion 42 may be provided, contacting on the network 2 as a server for instance, separately from the network speaking control unit 50. On this occasion, the network 2 is watched and the data at the time of downloading is identified so as to detect the number of the download of the software and the number of download of the encoded data.

Besides, how to sort the measurement and computing (such as A, B, C, D, . . . ) and its weighting, and the quantity of use computed as shown in FIG. 5 are simply shown for the convenience of explanation, so the kinds are further sorted so as to weight. On this occasion, the speaking terminals are identified as to whether or not the encoded data is downloaded to the speaking terminal so that the weighting of the quantity of load at the time of measuring and computing can be made different.

The present invention is explained on the basis of the embodiment heretofore. The embodiments which are described in the present specification are illustrative and not limiting. The scope of the invention is designated by the accompanying claims and is not restricted by the descriptions of the specific embodiments. Accordingly, all the transformations and changes belonging to the claims are included in the scope of the present invention.

1. A quality evaluation equipment of network speaking to be used for a network speaking system for speaking with voice between a plurality of speaking terminals by exchanging speaking data comprised of a plurality of voice packets through a communication network,
said quality evaluation equipment of network speaking comprising:
speaking quality monitoring units for measuring and computing speaking quality evaluation data through which speaking quality of network speaking can be evaluated, provided between said communication network and a plurality of said speaking terminals, and a speaking control unit for collecting said speaking quality evaluation data;
said speaking control unit further comprising:
means of detecting computing contents for detecting a kind and a number of said measurement and computing in each of a plurality of said speaking terminals;
means of computing quantity of load for computing quantity of load on the basis of said kind and said number of said measurement and computing;
means of recording computing contents for recording said kind and said number of said measurement and computing detected by said means of detecting computing contents, and said quantity of load computed by said means of computing quantity of load.

2. The quality evaluation equipment of network speaking according to claim 1, wherein said means of detecting computing contents detects measurement and computing of jitter, disappearing, delay, reciprocating delay time and objective tone evaluation value concerning said voice packet as a kind of said measurement and said computing every said kind, and said means of computing said quantity of load computes said quantity of load on the basis of load on said every kind and number.

3. The quality evaluation equipment of network speaking according to claim 1, further comprising:
means of distributing software provided on said communication network, said means of distributing software capable of distributing a program for measurement for measuring and computing said speaking quality evaluation data to said speaking quality monitoring unit, wherein said means of recording computing contents records number of distribution of said program for measurement by said means of distributing software and quantity of load by said distribution.

4. The quality evaluation equipment of network speaking according to claim 1, further comprising:
means of distributing encoded data provided on said communication network, said means of distributing encoded data capable of distributing encoded data obtained by encoding voice data to be used for measurement to said speaking quality monitoring unit, wherein said speaking quality monitoring unit measures said speaking quality evaluation data on the basis of said encoded data distributed, and said means of recording computing contents records number of distribution of said encoded data by said means of distributing encoded data and quantity of load by said distribution.

5. The quality evaluation equipment of network speaking according to claim 4, wherein said means of distributing encoded data has said encoded data every kind of codec.

6. The quality evaluation equipment of network speaking according to claim 1, wherein said speaking quality monitoring unit is a computer.

7. A quality evaluation equipment of network speaking to be used for a network speaking system for speaking with voice between a plurality of speaking terminals by exchanging speaking data comprised of a plurality of voice packets through a communication network,
said quality evaluation equipment of network speaking comprising:
speaking quality monitoring units for measuring and computing speaking quality evaluation data through which speaking quality of network speaking can be evaluated, provided between said communication network and a plurality of said speaking terminals, and a speaking control unit for collecting said speaking quality evaluation data;
said speaking control unit further comprising:
computing contents detecting unit for detecting a kind and a number of said measurement and computing in each of a plurality of said speaking terminals;
quantity of load computing unit for computing quantity of load on the basis of said kind and said number of said measurement and computing;
computing contents record unit for recording said kind and said number of said measurement and computing detected by said computing contents detecting unit, and said quantity of load computed by said quantity of load computing unit.

8. The quality evaluation equipment of network speaking according to claim 7, wherein said computing contents detecting unit detects measurement and computing of jitter, disappearing, delay, reciprocating delay time and objective tone evaluation value concerning said voice packet as a kind of said measurement and said computing every said kind, and said quantity of load computing unit computes said quantity of load on the basis of load on said every kind and number.

9. The quality evaluation equipment of network speaking according to claim 7, further comprising:
software distributing unit provided on said communication network, said software distributing unit capable of distributing a program for measurement for measuring and computing said speaking quality evaluation data to said speaking quality monitoring unit, wherein said computing contents record unit records number of distribution of said program for measurement by said software distributing unit and quantity of load by said distribution.

10. The quality evaluation equipment of network speaking according to claim 7, further comprising:
encoded data distributing unit provided on said communication network, said encoded data distributing unit capable of distributing encoded data obtained by encoding voice data to be used for measurement to said speaking quality monitoring unit, wherein said speaking quality monitoring unit measures said speaking quality evaluation data on the basis of said encoded data distributed, and said computing contents record unit records number of distribution of said encoded data by said encoded data distributing unit and quantity of load by said distribution.

11. The quality evaluation equipment of network speaking according to claim 10, wherein said encoded data distributing unit has said encoded data every kind of codec.

12. The quality evaluation equipment of network speaking according to claim 7, wherein said speaking quality monitoring unit is a computer.
